(19) United States
(12) Patent Application Publication
(10) Pub. No.: US 2025/0121891 A1
(43) Pub. Date: Apr. 17, 2025

(54) CROSS BAR ATTACHMENT INTERFACE TO BASE PLATE

(71) Applicant: Ford Global Technologies, LLC, Dearborn, MI (US)

(72) Inventors: Matthew B. Rutman, Westland, MI (US); Blaise Nugent, Brighton, MI (US); Alison Palmer, Royal Oak, MI (US); Norbert Zolnai, Windsor (CA); Stuart C. Salter, White Lake, MI (US)

(21) Appl. No.: 18/380,254

(22) Filed: Oct. 16, 2023

(51) Int. Cl. B62D 33/02; B60R 9/06

(52) U.S. Cl. CPC B62D 33/0207; B60R 9/06

(57) ABSTRACT

An attachment structure includes a cross bar body extending between a first end and a second end, a first mount coupled to the first end, and a second mount coupled to the second end. The first mount and the second mount each include at least one cleat that is selectively securable to a base plate that includes a plurality of mounting apertures.

### TECHNICAL FIELD

This disclosure relates generally to an attachment structure used to secure a cross bar to a base plate in a cargo area.

### BACKGROUND

Vehicles transport various types of cargo. A cross bar can be attached to a vehicle to support larger items, e.g. travel storage boxes, kayaks, bikes, etc., for transportation purposes. Vehicles can also include base plates with mounting apertures that are configured to support various different types of cargo, e.g. tool boxes, storage containers, coolers, etc. Providing for quick and secure mounting of cross bars to such plates can be challenging.

### SUMMARY

An attachment structure according to an exemplary aspect of the present disclosure includes, among other things: a cross bar body extending between a first end and a second end; a first mount coupled to the first end; and a second mount coupled to the second end, wherein the first mount and the second mount each include at least one cleat that is selectively securable to a base plate that includes a plurality of mounting apertures.

In a further non-limiting embodiment of the foregoing attachment structure, each end of the cross bar body includes an attachment opening, and wherein the first mount and the second mount each include an end cap with a leg extension that is received within the attachment opening to secure the end cap to the cross bar body.

In a further non-limiting embodiment of any of the foregoing attachment structures, the first mount is adjustable and the second mount is fixed.

In a further non-limiting embodiment of any of the foregoing attachment structures, the first mount includes an actuator that rotates a shaft to move the at least one cleat between a locked position and an unlocked position.

In a further non-limiting embodiment of any of the foregoing attachment structures, the first mount includes a lock moveable between a blocking position to prevent rotation of the actuator and an unblocking position to allow rotation of the actuator.

In a further non-limiting embodiment of any of the foregoing attachment structures, the lock comprises a lock pin that is biased to the blocking position.

In a further non-limiting embodiment of any of the foregoing attachment structures, the at least one cleat of the second mount is fixed relative to the cross bar body with at least one clamp bar.

An attachment structure according to an exemplary aspect of the present disclosure includes, among other things: a base plate having a plurality of mounting apertures; a cross bar extending between a first end and a second end; a first mount coupled to the first end, the first mount including a first cleat receivable within a first mounting aperture of the plurality of mounting apertures; and a second mount coupled to the second end, the second mount including a second cleat receivable within a second mounting aperture of the plurality of mounting apertures, wherein the first cleat is selectively adjustable relative to the cross bar and the second cleat is fixed relative to the cross bar.

In a further non-limiting embodiment of any of the foregoing attachment structures, the first mount includes an actuator that moves the first cleat between a locked position where the cross bar is locked to the base plate and an unlocked position where the cross bar is removable from the base plate.

In a further non-limiting embodiment of any of the foregoing attachment structures, the actuator comprises a knob that is rotatable, and wherein the first mount includes a lock pin moveable between a blocking position to prevent rotation of the knob and an unblocking position to allow rotation of the knob.

In a further non-limiting embodiment of any of the foregoing attachment structures, the lock pin is biased to the blocking position.

In a further non-limiting embodiment of any of the foregoing attachment structures, the first cleat comprises a first mounting foot with a first protruding portion, and wherein: when the first cleat is in the locked position, the first protruding portion extends underneath a surface of the base plate that surrounds the first mounting aperture; and when the first cleat is in the unlocked position, the first protruding portion is aligned with the first mounting aperture such that the first cleat can be moved out of the first mounting aperture.

In a further non-limiting embodiment of any of the foregoing attachment structures, the second cleat comprises a second mounting foot with a second protruding portion, and wherein: when the actuator is moved to one of the locked position and unlocked position, the first protruding portion is drawn towards the second protruding portion, and wherein when the actuator is moved to the other of the locked position and unlocked position, the first protruding portion is pushed away from the second protruding portion.

In a further non-limiting embodiment of any of the foregoing attachment structures, each of the first end and the second end of the cross bar includes an attachment opening, and wherein: the first mount includes a first end cap with a first leg extension that is received within the attachment opening to secure the first end cap to the cross bar, the first end cap being positioned between the actuator and the first end of the cross bar; and the second mount includes a second end cap with a second leg extension that is received within the attachment opening to secure the second end cap to the second end of the cross bar.

In some aspects, the techniques described herein relate to a method of attaching a cross bar to a base plate including a plurality of mounting apertures, the cross bar extending from a first end including a first mount to a second end including a second mount, the method comprising: inserting a first cleat of the first mount into a first mounting aperture of the plurality of mounting apertures; inserting a second cleat of the second mount into a second mounting aperture of the plurality of mounting apertures; and selectively adjusting a position of the first cleat relative to the cross bar and the base plate to secure the cross bar to the base plate.

In a further non-limiting embodiment of the foregoing method, the method includes coupling an actuator to the first cleat, selectively moving the actuator between a locked position where the cross bar is locked to the base plate and an unlocked position where the cross bar is removable from the base plate.

In a further non-limiting embodiment of any of the foregoing methods, the method includes rotating the actuator between the locked position and unlocked position, wherein rotation of the actuator causes linear movement of the first cleat relative to the base plate.

In a further non-limiting embodiment of any of the foregoing methods, the method includes selectively moving a lock pin between a blocking position to prevent rotation of the actuator and an unblocking position to allow rotation of the actuator.

In a further non-limiting embodiment of any of the foregoing methods, the method includes biasing the lock pin to the blocking position.

In a further non-limiting embodiment of any of the foregoing methods, the method includes fixing the second cleat to the cross bar such that only the first cleat is adjustable relative to the cross bar.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1A illustrates a perspective view of a vehicle having a cargo bed equipped with base plates that can be used to secure a cross bar according to an exemplary aspect of the present disclosure.

FIG. 1B illustrates a perspective view of a van having a cargo area equipped with base plates that can be used to secure a cross bar according to an exemplary aspect of the present disclosure.

FIG. 1C illustrates a perspective view of a vehicle having a cargo bed equipped with a cross bar attached to a base plate according to an exemplary aspect of the present disclosure.

FIG. 2 is a side view of a cross bar having a first mount at one end and a second mount at an opposite end.

FIG. 3 is an exploded view of the first mount as shown in FIG. 2.

FIG. 4 is an assembled view of the first mount of FIG. 3.

FIG. 5A is perspective view of the first mount of FIG. 4 in a blocking position.

FIG. 5B is a view similar to that of FIG. 5A but showing a lock pin that can be moved to an unblocking position.

FIG. 5C is an end view of the first mount of FIG. 4 with a knob removed.

FIG. 6 is an exploded view of the second mount as shown in FIG. 2.

FIG. 7 is an assembled view of the second mount of FIG. 6.

### DETAILED DESCRIPTION

The subject disclosure provides an attachment structure used to secure a cross bar to a base plate in a cargo area. The attachment structure includes mounting cleats on ends of the cross bar that are each inserted into one of a plurality of mounting apertures in the base plate. An accessory can then be secured to, or supported by, the cross bar. The base plates can be mounted to a floor structure or a wall structure. The attachment structure for the cross bar can be quickly and easily attached/detached to the base plate without the use of tools.

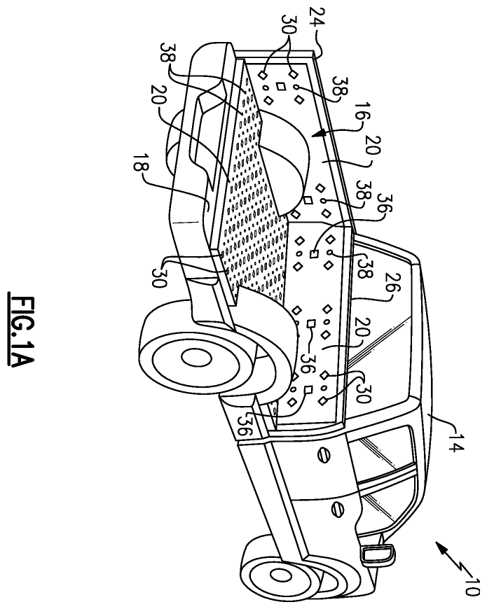

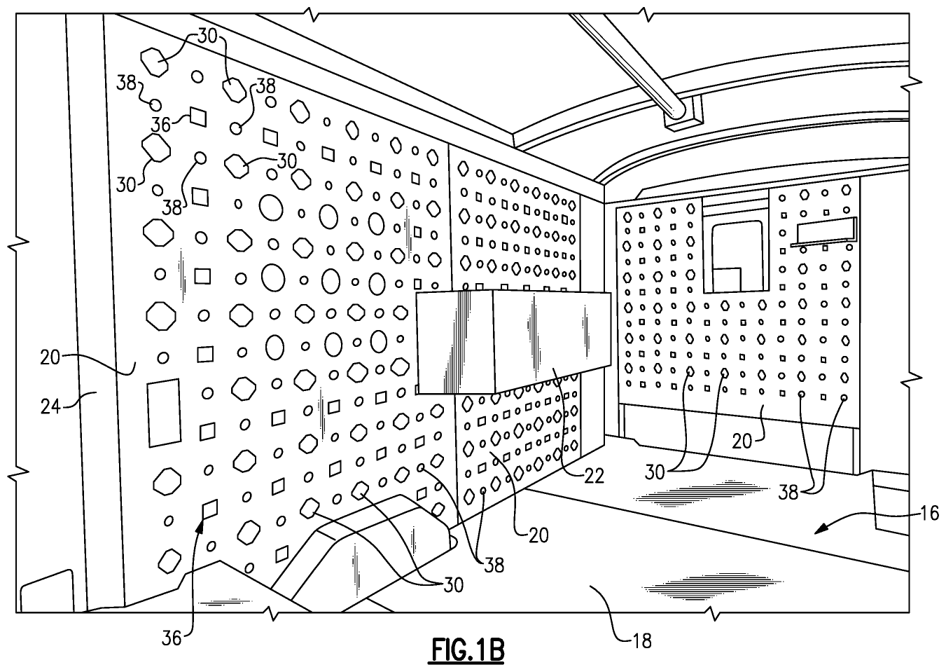

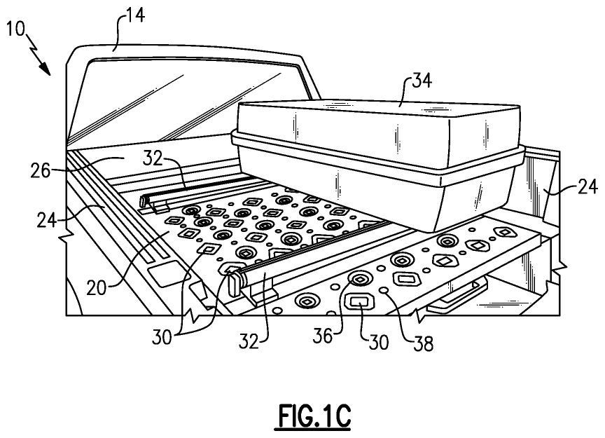

In one example, an attachment system for accessories is used on a vehicle. With reference to FIGS. 1A-1C, a vehicle 10 includes a passenger compartment 14 and a cargo area 16 that is aft of the passenger compartment 14. The cargo area 16 has a floor 18. In the example of FIG. 1A, the vehicle 10 is a pickup truck. However, the vehicle 10 could be another type of vehicle in another example, such as a car, van, sport utility vehicle, etc. FIG. 1B shows an example of a van that incorporates a base plate 20 that can be used with accessories 22, such as a cross bar for example.

In the exemplary embodiment, one or more base plates 20 are used to support one or more accessories and/or modules 22. In one example, the cargo bed 16 is defined by a pair of side walls 24 (only one is shown in FIG. 1A for purposes of clarity), a rear wall 26, and a tailgate (not shown). In one example, the base plates 20 are secured directly to walls 24, 26 and/or to the floor 18 of the cargo area 16 by fastening, welding, etc., at a first connection interface. The accessories and/or modules 22 can be secured to the vehicle 10 by engaging one or more of the base plates 20 via a second connection interface separate from the first connection interface.

As shown in FIGS. 1A-1C, the base plates 20 include a plurality of mounting openings or apertures 30. As shown in FIG. 1C, an example module 22 comprises one or more cross bars 32 that are secured to the base plate 20 via a mechanical connection interface. Additional items 34, such as storage boxes, bikes, kayaks, etc., can then be attached to the cross bars 32.

In one example, the base plate 20 also includes other openings or apertures 36 (FIGS. 1A-1B) for a power connection interface, and further includes additional openings or locking apertures 38 to facilitate locking of items to the base plate 20. The power apertures 36 and locking apertures 38 are spaced apart and separate from each other and from the mounting apertures 30. In one example, the apertures 30, 36, 38 can have shapes and/or sizes that are different from each other. These sets of apertures 30, 36, 38 are provided at multiple locations on the base plate 20, and are formed in a desired pattern on the base plate 20 to allow for attachment structures associated with the cross bars 32 to be mounted in various different locations as needed. In one example, the mounting apertures 30 are formed to have a diamond shape and are larger in size than the power apertures 36 and locking apertures 38.

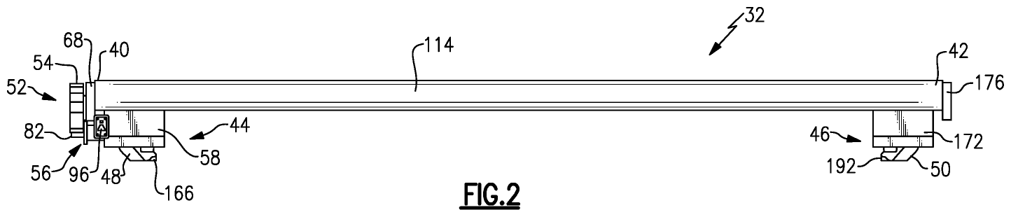

FIG. 2 shows one example of a cross bar 32 extending between a first end 40 and a second end 42. A first mount structure 44 is coupled to the first end 40 and a second mount structure 46 is coupled to the second end 42. In one example, the first mount structure 44 includes a first mounting foot or cleat 48 that is receivable within a first mounting aperture 30 and the second mount structure 46 includes a second mounting foot or cleat 50 that is receivable within a second mounting aperture 30. The apertures 30 are spaced upwardly from the floor 18 or side wall 24, 26 by an open gap such that the cleats 48, 50 can be easily inserted into the base plate 20.

In one example, the first cleat 48 is selectively adjustable relative to the cross bar 32 and the second cleat 50 is fixed relative to the cross bar 32. In one example, the first mount structure 44 includes an actuator 52 that moves the first cleat 48 between a locked position where the cross bar 32 is locked to the base plate 20 and an unlocked position where the cross bar 32 is removable from the base plate 20. In one example, the actuator 52 comprises a knob 54 that is rotatable. In one example, the first mount structure 44 further includes a lock member 56 that is moveable between a blocking position to prevent rotation of the knob 54 and an unblocking position to allow rotation of the knob 54.

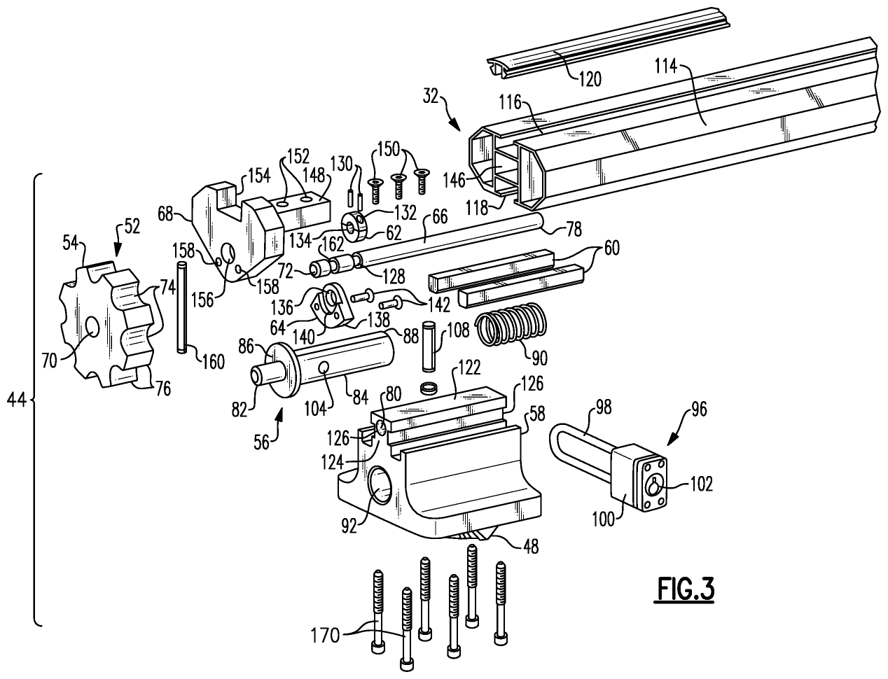

FIG. 3 shows one example of the first mount structure 44 in greater detail. In addition to the knob 54 of the actuator 52 and the lock member 56, the first mount structure 44 includes a tower 58, one or more glide bars 60, a collar 62, a collar retainer 64, a threaded shaft 66, and an end cap 68. In one example, the knob 54 comprises a disc-shaped body having a center opening 70 that threadably engages one end 72 of the threaded shaft 66. A peripheral surface about the disc-shaped body includes a plurality of recesses 74 and protrusions 76 that alternate with each other. In one example, the recesses 74 and protrusions 76 form a castellation-like structure. An opposite end 78 of the threaded shaft 66 is threaded into an opening 80 formed in the tower 58. Turning movement of the knob 54 is translated into axial movement of the tower 58 along the shaft 66 to move the first cleat 48 between the locking and unlocking positions.

In one example, the lock member 56 comprises a lock pin 82 that moves between the blocking position to prevent rotation of the knob 54 and the unblocking position to allow rotation of the knob 54. The lock pin 82 extends outwardly from a cylindrical body 84, wherein an enlarged flange or collar portion 86 separates the lock pin 82 from the cylindrical body 84. In one example, the collar portion 86 has a greater outer diameter than the lock pin 82 and the cylindrical body 84. The cylindrical body 84 extends from the collar portion 86 to a distal end 88 that comprises a support surface for one end of a resilient member 90. In one example, the resilient member 90 comprises a coil spring. The resilient member 90 is received within an internal cavity 92 formed within the tower 58. One end of the resilient member 90 is supported against the distal end 88 of the cylindrical body 84 and an opposite end of the resilient member 90 is supported against an end wall 94 of the internal cavity 92 within the tower 58.

In the blocking position (FIG. 4), the lock pin 82 is received within one of the recesses 74 of the knob 54, and the collar portion 86 abuts against a rear face of the knob 54, which defines a stop for the blocking position. The resilient member 90 biases the lock pin 82 toward the blocking position. This prevents the knob 54 from turning. To move the lock pin 82 to the unblocked position, the lock pin 82 would be manually pressed toward the tower 58 to overcome the biasing force of the resilient member 90. Once the lock pin 82 is moved out of the recess 74, the knob 54 can be rotated and the position of the first cleat 48 can be adjusted.

Optionally, an additional lock 96 can be included as part of the first mount structure 44. In

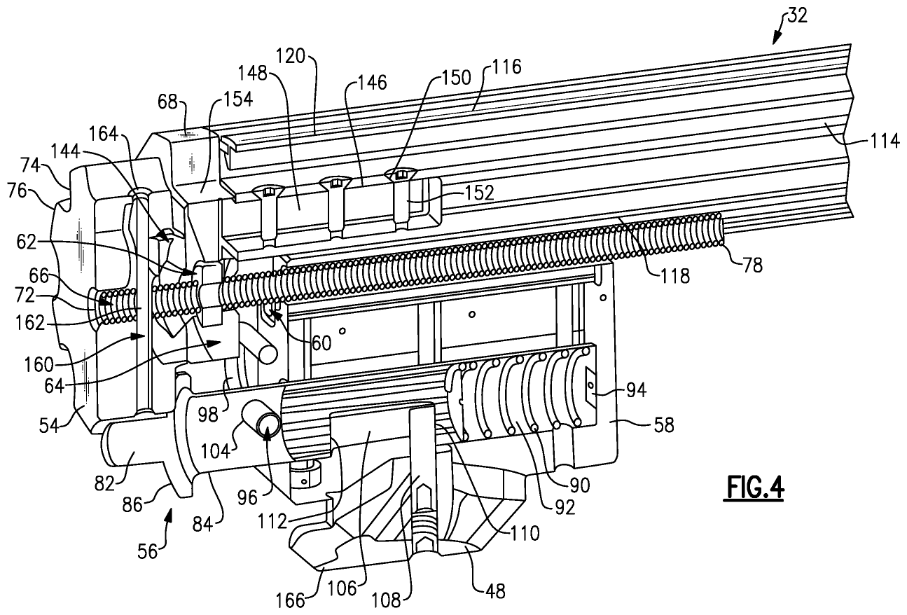

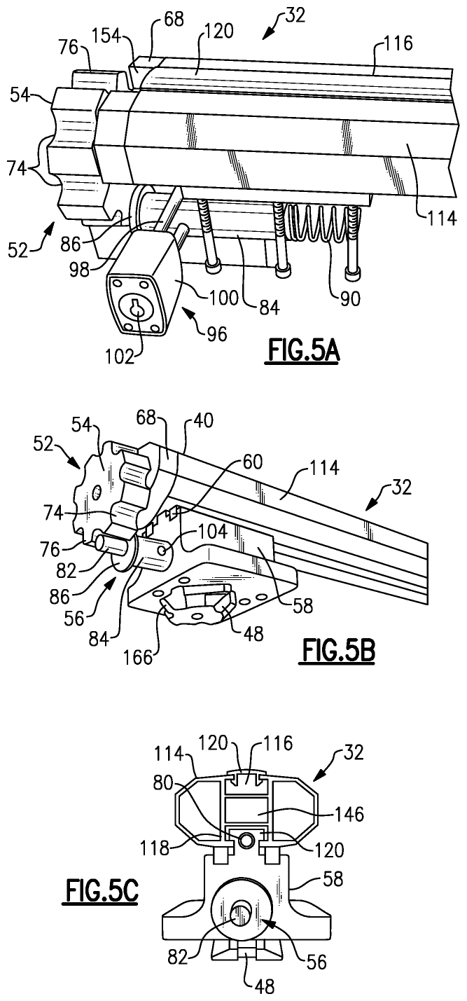

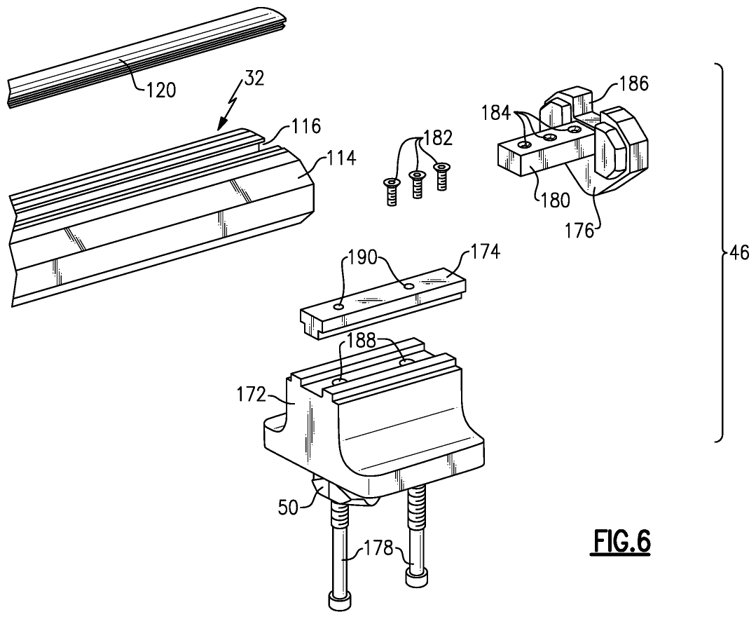

In one example, the additional lock 96 comprises a padlock having a shackle 98 that is selectively coupled to a lock body 100 that includes an internal locking mechanism (not shown) that can be locked/unlocked via an input interface 102 that interacts via a key or code. In this example, the cylindrical body 84 includes a lock opening 104 through which the shackle 98 can be inserted and locked to the lock body 100 to provide a locked condition (FIG. 5A). When in the locked condition, the lock pin 82 can not be moved relative to the knob 54.

To unlock the knob 54, the key or code interacts with the input interface 102 to unlock the shackle 98 from the lock body 100. The shackle 98 is removed from the lock opening 104 (FIG. 5B), and the lock pin 82 can be pushed out of engagement with the knob 54. The knob 54 can then be rotated to adjust the position of the first cleat 48.

The first mount structure 44 may also include a travel stop to limit the travel of the lock member 56. In one example, the cylindrical body 84 includes a recess or slot 106 that is open to an external surface of the cylindrical body 84. A travel pin 108, fixed to the first cleat 48, extends upwardly into the slot 106. One end 110 of the slot 106 engages the travel pin 108 (FIG. 4) to provide a stop in the blocking direction. This also prevents the lock member 56 from sliding out of the cavity 92 and becoming detached from the tower 58. An opposite end 112 of the slot 106 engages the travel pin 108 to define a stop when moving to the unblocking position.

In one example, the cross bar 32 comprises a load bar body 114 that includes an upper slot 116 and a lower slot 118. An infill strip 120 is received within the upper slot 116. In one example, the tower 58 includes a key or connector 122 that fits within the lower slot 118 (FIG. 5C). In one example, the connector 122 comprises a T-shaped structure with opposing legs that are slidably received within the slot 118. The opening 80 for the threaded shaft 66 is located in the connector 122 between the opposing legs.

In one example, a neck portion 124 extends from the connector 122 to an upper body portion of the tower 58. The upper portion includes a channel 126 on each side of the neck portion 124. Each channel 126 receives one glide bar 60. The glide bars 60 reduce friction and facilitate movement of the tower 58 as the first cleat 48 is moved between the locked and unlocked positions. In one example, the glide bars 60 are made from a material such as HPDE, Teflon, or other similar low-friction materials.

In one example, the collar 62 is fixed to the threaded shaft 66 at a non-threaded portion 128 such that the collar 62 rotates with the shaft 66. Pins 130 extend through associated openings 132 in the collar 62 and are received on opposing sides of the non-threaded portion 128. The collar 62 includes an opening 134 that aligns with an opening 136 of the collar retainer 64 to receive the shaft 66. The collar retainer 64 includes an enlarged lower body portion 138 with a recess 140 that receives the collar 62. Pins 142 secure the collar retainer 64 to an optional clutch 144 (FIG. 4) or to the end cap 68 (FIG. 3 embodiment without clutch) via openings 158. The clutch 144 would be used under certain configurations such that it cannot be over-tightened.

The first mount structure 44 also includes the end cap 68. In one example, the load bar body 114 include an internal cavity 146 located between the upper 116 and lower 118 slots. In one example, the end cap 68 includes a leg extension 148 that is received within the internal cavity 146 to secure the end cap 68 to the load bar body 114. A plurality of fasteners 150 are inserted through the upper slot 116 and extend through openings 152 in the leg extension 148 to secure the end cap 68 to the load bar body 114. The end cap 68 includes a notch 154 in an outer periphery that aligns with the upper slot 116. The end cap 68 is positioned between the knob 54 and the first end 40 of the load bar body 114 and includes an opening 156 that receives the shaft 66.

In one example, a split pin 160 is inserted through an opening 162 in the shaft 66. An opening 164 extends through the knob 54 and intersects the opening 70. The split pin 160 is received within the opening 164. The split pin 160 rotates with the knob 54 and shaft 66 and keeps the shaft 66 from advancing as the first cleat 48 moves between the locked and unlocked positions.

In one example, the first cleat 48 comprises a first mounting foot with a first protruding portion 166, and wherein when the first cleat 48 is moved to the locked position, the first protrusion 166 extends underneath a surface of the base plate 20 that surrounds the first mounting aperture 30. When the first cleat 48 is moved to the unlocked position, the first protrusion 166 moves back into alignment with the first mounting aperture 30 such that the first cleat 48 can be withdrawn from the mounting aperture 30.

In one example, the tower 58 comprises a single molded attachment that is formed with no screws or other fasteners. In one example, the material is glass fiber reinforced nylon 6/6 or the tower 58 could be molded from a metal material. The mounting cleat 48 could be molded integrally with the tower or can be separately attached with fasteners 170.

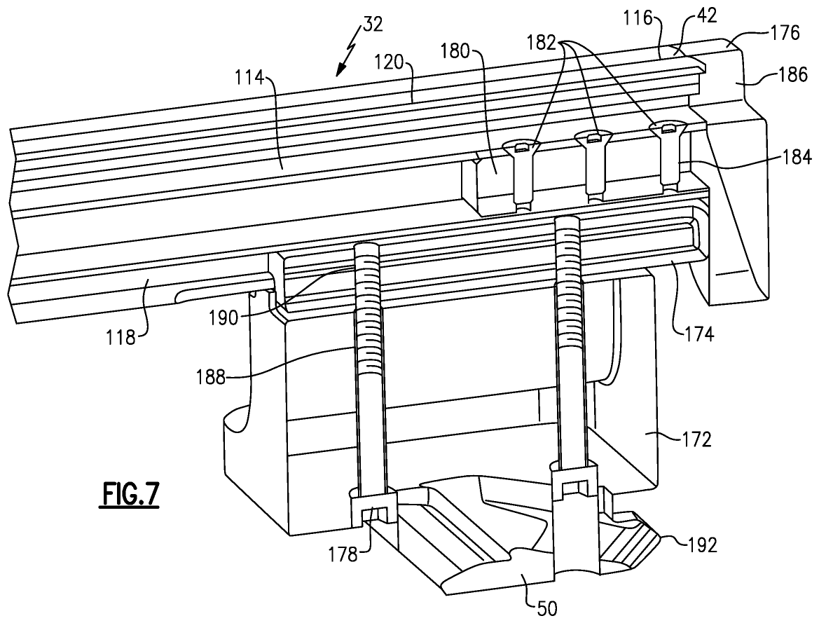

FIGS. 6-7 show one example of the second mount structure 46 in greater detail. The second mount structure 46 includes a tower 172, a clamp bar 174, and an end cap 176. The tower 172 comprises a single molded attachment, similar to tower 58; however, the tower 172 is fixed to the load bar body 114 such that the tower 172 is not moveable relative to the cross bar 32. In one example, the clamp bar 174 is received within the lower slot 118 of the body 114 and the tower 172 is secured to the clamp bar 174 with fasteners 178 via aligned openings 188 in the tower 172 and openings 190 in the clamp bar 174.

In one example, the end cap 176 for the second mount structure 46 is attached to the second end 42 of the cross bar 32. In one example, the end cap 176 includes a leg extension 180 that is received within the internal cavity 146 of the body 114 to secure the end cap 176 to the load bar body 114. A plurality of fasteners 182 are inserted through the upper slot 116 and extend through openings 184 in the leg extension 180 to secure the end cap 176 to the load bar body 114. The end cap 176 includes a notch 186 in an outer periphery that aligns with the upper slot 116.

In one example, the second cleat 50 comprises a second mounting foot with a second protruding portion 192 (FIG. 7). FIG. 2 shows one example configuration for the first protruding portion 166 of the first cleat 48 and the second protruding portion 192 of the second cleat 50. In this example the protruding portions 166, 192 face inwardly toward each other. In another example, the protruding portions 166, 192 face outwardly away from each other (FIG. 4).

In one example, when the knob 54 is moved to one of the locked position and unlocked position, the first protruding portion 166 is drawn towards the second protruding portion 192, and when the knob 54 is moved to the other of the locked position and unlocked position, the first protruding portion 166 is pushed away from the second protruding portion 192. As discussed above, when in the locked position, the first protruding portion 166 is drawn underneath an edge of a corresponding mounting aperture 30 in the base plate which also causes the second protruding portion 192 to be positioned underneath an edge of a corresponding mounting aperture 30. In this position, the cross bar 32 cannot be removed from the base plate 20. When in the unlocked position, the protruding portion 166 is moved to align with the corresponding mounting aperture 30 and the second protruding portion 192 aligned with the corresponding mounting aperture 30. In this position, the cross bar 32 can be removed from the base plate 20.

An example method of attaching a cross bar 32 to a base plate 20 with a plurality of mounting apertures 30 includes inserting a first cleat 48 into a first mounting aperture 30, inserting a second cleat 50 into a second mounting aperture 30, and selectively adjusting a position of the first cleat 48 relative to the cross bar 32 and the base plate 20 to secure the cross bar 32 to the base plate 20.

An example method can further include any of the following steps either alone or in any combination. For example, the method includes coupling an actuator 52 to the first cleat 48, selectively moving the actuator 52 between a locked position where the cross bar 32 is locked to the base plate 20 and an unlocked position where the cross bar 32 is removable from the base plate 20.

For example, the method includes rotating the actuator 52 between the locked position and unlocked position, wherein rotation of the actuator 52 causes linear movement of the first cleat 48 relative to the base plate 20.

For example, the method includes selectively moving a lock pin 82 between a blocking position to prevent rotation of the actuator 52 and an unblocking position to allow rotation of the actuator 52.

For example, the method includes biasing the lock pin 82 to the blocking position.

For example, the method includes fixing the second cleat 50 to the cross bar 32 such that only the first cleat 48 is adjustable relative to the cross bar 32.

The subject disclosure provides an attachment structure for a cross bar that can quickly and easily attach to a base plate. Further, the attachment structure has high strength and is reversible to accommodate easy attachment/removal depending on where other items are to be placed on the base plate. No tools or fasteners are needed for fast and easy attachment of the cross bar to the mounting apertures on the base plate.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An attachment structure, comprising:
a cross bar body extending between a first end and a second end;
a first mount coupled to the first end; and
a second mount coupled to the second end, wherein the first mount and the second mount each include at least one cleat that is selectively securable to a base plate that includes a plurality of mounting apertures.

2. The attachment structure of claim 1, wherein each end of the cross bar body includes an attachment opening, and wherein the first mount and the second mount each include an end cap with a leg extension that is received within the attachment opening to secure the end cap to the cross bar body.

3. The attachment structure of claim 1, wherein the first mount is adjustable and the second mount is fixed.

4. The attachment structure of claim 3, wherein the first mount includes an actuator that rotates a shaft to move the at least one cleat between a locked position and an unlocked position.

5. The attachment structure of claim 4, wherein the first mount includes a lock moveable between a blocking position to prevent rotation of the actuator and an unblocking position to allow rotation of the actuator.

6. The attachment structure of claim 5, wherein the lock comprises a lock pin that is biased to the blocking position.

7. The attachment structure of claim 3, wherein the at least one cleat of the second mount is fixed relative to the cross bar body with at least one clamp bar.

8. An attachment system, comprising:
a base plate having a plurality of mounting apertures;
a cross bar extending between a first end and a second end;
a first mount coupled to the first end, the first mount including a first cleat receivable within a first mounting aperture of the plurality of mounting apertures; and
a second mount coupled to the second end, the second mount including a second cleat receivable within a second mounting aperture of the plurality of mounting apertures, wherein the first cleat is selectively adjustable relative to the cross bar and the second cleat is fixed relative to the cross bar.

9. The attachment system of claim 8, wherein the first mount includes an actuator that moves the first cleat between a locked position where the cross bar is locked to the base plate and an unlocked position where the cross bar is removable from the base plate.

10. The attachment system of claim 9, wherein the actuator comprises a knob that is rotatable, and wherein the first mount includes a lock pin moveable between a blocking position to prevent rotation of the knob and an unblocking position to allow rotation of the knob.

11. The attachment system of claim 10, wherein the lock pin is biased to the blocking position.

12. The attachment system of claim 9, wherein the first cleat comprises a first mounting foot with a first protruding portion, and wherein:
when the first cleat is in the locked position, the first protruding portion extends underneath a surface of the base plate that surrounds the first mounting aperture; and
when the first cleat is in the unlocked position, the first protruding portion is aligned with the first mounting aperture such that the first cleat can be moved out of the first mounting aperture.

13. The attachment system of claim 12, wherein the second cleat comprises a second mounting foot with a second protruding portion, and wherein:
when the actuator is moved to one of the locked position and unlocked position, the first protruding portion is drawn towards the second protruding portion, and
wherein when the actuator is moved to the other of the locked position and unlocked position, the first protruding portion is pushed away from the second protruding portion.

14. The attachment system of claim 9, wherein each of the first end and the second end of the cross bar includes an attachment opening, and wherein:
the first mount includes a first end cap with a first leg extension that is received within the attachment opening to secure the first end cap to the cross bar, the first end cap being positioned between the actuator and the first end of the cross bar; and
the second mount includes a second end cap with a second leg extension that is received within the attachment opening to secure the second end cap to the second end of the cross bar.

15. A method of attaching a cross bar to a base plate including a plurality of mounting apertures, the cross bar extending from a first end including a first mount to a second end including a second mount, the method comprising:
inserting a first cleat of the first mount into a first mounting aperture of the plurality of mounting apertures;
inserting a second cleat of the second mount into a second mounting aperture of the plurality of mounting apertures; and
selectively adjusting a position of the first cleat relative to the cross bar and the base plate to secure the cross bar to the base plate.

16. The method according to claim 15, including coupling an actuator to the first cleat, selectively moving the actuator between a locked position where the cross bar is locked to the base plate and an unlocked position where the cross bar is removable from the base plate.

17. The method according to claim 16, including rotating the actuator between the locked position and unlocked position, wherein rotation of the actuator causes linear movement of the first cleat relative to the base plate.

18. The method according to claim 17, including selectively moving a lock pin between a blocking position to prevent rotation of the actuator and an unblocking position to allow rotation of the actuator.

19. The method according to claim 18, including biasing the lock pin to the blocking position.

20. The method according to claim 15, including fixing the second cleat to the cross bar such that only the first cleat is adjustable relative to the cross bar.
